(19) United States
(12) Patent Application Publication
(10) Pub. No.: US 2004/0202324 A1
(43) Pub. Date: Oct. 14, 2004

(54) Program electronic watermark processing apparatus

(75) Inventors: Takao Yamaguchi, Tokyo (JP); Tomoaki Itoh, Kawasaki-shi (JP); Yuji Sato, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd, Osaka (JP)

(21) Appl. No.: 10/813,091

(22) Filed: Mar. 31, 2004

(30) Foreign Application Priority Data
Apr. 11, 2003 (JP) 2003-108320

(51) Int. Cl. H04L 9/00

(52) U.S. Cl. 380/201; 713/176

(57) ABSTRACT

In the present invention, a software watermarking is input to add to an updated program, while a differential program is input to update an original program, the original program is updated using the input differential program, and the input software watermarking is inserted into the updated program, whereby it is possible to prevent the software watermarking from being deleted even when the program is updated.

### BACKGROUND OF THE INVENTION

1. Field of the Invention

The present invention relates to a program software watermarking processing apparatus for preventing and inhibiting unauthorized use and distribution of a program.

2. Description of Related Art

With the progress of computer networks, it becomes common to distribute a computer program through networks. Since a computer program can be copied easily, there is a possibility that a copy of the program undergoes unauthorized secondary distribution or the algorithm of the program is stolen or tampered. Accordingly, it is necessary to protect programs from such unauthorized uses.

One of conventional techniques for protecting programs is a method of inserting a software watermarking into a program. In this method, watermark information varying with distribution destination is embedded in a program to distribute. When an unauthorized use occurs, the watermark information is extracted from the program of the unauthorized user and analyzed. By this means, it is possible to easily detect an outflow source.

An example of a specific method of inserting the watermark is disclosed in JP2000-76064. In this method, a code is first detected that is not dependent on the execution order. Then, calculation of dummy variable is inserted in the detected portion. The execution order of the detected portion including the calculation of dummy variables is exchanged at random. Performing such processing implements a mechanism for varying the execution order as the software watermarking information for each distribution destination.

It has been carried out conventionally that a differential of source code or binary code in a program is obtained from a diff command of UNIX(R) or the like and the differential is used for storing or updating the source code or binary code.

However, the conventional method of updating a program using the differential does not consider software watermarking to a program. Therefore, there is a possibility that updating the program using the differential deletes a software watermarking of the program.

As described above, the conventional method of inserting a software watermarking into a program has a problem that the update using the differential facilitates tamper and/or deletion of the watermark.

Further, since the update using the differential in conventional techniques has no consideration of security, there are problems that the program is updated improperly, and processing is carried out improperly for reading, inserting, and/or deleting a software watermarking of the program.

### SUMMARY OF THE INVENTION

It is an object of the present invention to prevent unauthorized processing for reading, inserting, and/or deleting a software watermarking of a program from being carried out while updating the program in security, even when the program is updated.

The present invention is to input a differential program to update an original program and a software watermarking for the updated program, update the original program using the input differential program, and insert the input software watermarking into the updated program.

It is thereby possible to prevent unauthorized execution of the processing for reading, inserting, and/or deleting a software watermarking of a program while performing update of the program in security, even when update of the program is performed.

### BRIEF DESCRIPTION OF THE DRAWINGS

The above and other objects and features of the invention will appear more fully hereinafter from a consideration of the following description taken in connection with the accompanying drawing wherein one example is illustrated by way of example.

FIG. 1 is a block diagram of a program unauthorized distribution prevention system using insertion of a watermark according to a first embodiment of the present invention;

FIG. 2 is a conceptual view for illustrating a method of inserting a watermark into an updated program in the program unauthorized distribution prevention system according to the first embodiment;

FIG. 3 is a block diagram of a watermark inserting apparatus according to the first embodiment;

FIG. 4 is a view for illustrating a specific method of inserting a software watermarking into a program in a watermark inserting section according to the first embodiment;

FIG. 5 is a block diagram of a watermark extracting apparatus according to the first embodiment;

FIG. 6 is a diagram of a watermark processing apparatus according to the first embodiment;

FIG. 7 is a flowchart of processing for transmitting a program in a watermark inserting apparatus according to the first embodiment;

FIG. 8 is a flowchart of processing for updating an original program with a watermark in the watermark processing apparatus according to the first embodiment;

FIG. 9 is a conceptual view for illustrating a method of inserting a watermark into an updated program in a program unauthorized distribution prevention system according to a second embodiment of the present invention;

FIG. 10 is a block diagram of a watermark inserting apparatus according to the second embodiment;

FIG. 11 is a block diagram of a watermark processing apparatus according to the second embodiment;

FIG. 12 is a flowchart of processing for transmitting a program in the watermark inserting apparatus according to the second embodiment;

FIG. 13 is a flowchart of processing for updating an original program with a watermark in the watermark processing apparatus according to the second embodiment;

FIG. 14 is a conceptual view for illustrating a method of inserting a watermark into an updated program in a program unauthorized distribution prevention system according to a third embodiment of the present invention;

FIG. 15 is a block diagram of a watermark inserting apparatus according to the third embodiment;

FIG. 16 is a block diagram of a watermark processing apparatus according to the third embodiment;

FIG. 17 is a flowchart of processing for transmitting a program in the watermark inserting apparatus according to the third embodiment;

FIG. 18 is a flowchart of processing for updating an original program with a watermark in the watermark processing apparatus according to the third embodiment;

FIG. 19 is a conceptual view for illustrating processing in a program unauthorized distribution prevention system according to a fourth embodiment of the present invention;

FIG. 20 is a block diagram of a watermark inserting apparatus according to the fourth embodiment;

FIG. 21 is a diagram of a watermark processing apparatus according to the fourth embodiment;

FIG. 22 is a flowchart of processing in the watermark inserting apparatus according to the fourth embodiment; and

FIG. 23 is a flowchart of processing in the watermark processing apparatus according to the fourth embodiment.

### DETAILED DESCRIPTION OF THE PREFERRED EMBODIMENTS

(First Embodiment)

Referring to accompanying drawings, following descriptions are given of a program unauthorized distribution prevention system provided with a program software watermarking processing apparatus according to the first embodiment of the present invention.

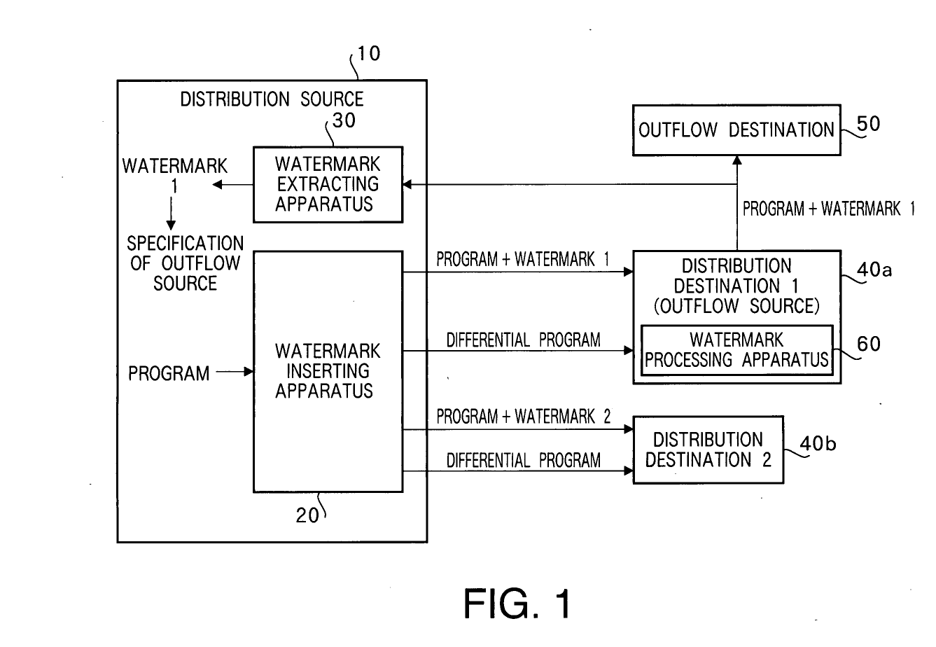

FIG. 1 is a block diagram of the program unauthorized distribution prevention system using insertion of watermark according to the first embodiment.

In order not to allow secondary distribution of programs in distribution destinations 40a and 40b, distribution source 10 inserts different (electronic) watermarks into original programs for each of distribution destinations 40a and 40b using a program software watermarking inserting apparatus (hereinafter, referred to as a watermark inserting apparatus) 20 to distribute as an original program with the watermark, in distributing the original programs.

By thus distributing an original program with a watermark embedded therein, when the original program with the watermark outflowed by unauthorized secondary distribution or the like, distribution source 10 extracts the watermark from the original program with the watermark that outflowed to outflow destination 50 using watermark extracting apparatus 30, checks a distribution destination, and is capable of specifying outflow source (distribution destination) 40a or 40b. Further, for fear of specification of an outflow source with the watermark, distribution destinations 40a and 40b withhold unauthorized secondary distribution.

Thus, the unauthorized distribution prevention system deters the unauthorized distribution of an original program due to the watermark.

Further, distribution source 10 transmits a differential program to update the already sent original program with the watermark to each of distribution destinations 40a and 40b. Using the differential program, each of distribution destinations 40a and 40b updates the original program with the watermark to generate an updated program.

In this way, in updating an already sent original program with the watermark, instead of transmitting the entire program updated in distribution source 10, the source 10 transmits only a differential program, and thus decreases a data amount to transmit to distribution destinations 40a and 40b.

In the case where the original program with the watermark is updated using a differential program having no consideration of the watermark to the program, there is a possibility that the watermark added to the original program is deleted from the updated program.

Therefore, the first embodiment provides a mechanism of inserting a watermark into an updated program that is updated using the differential program.

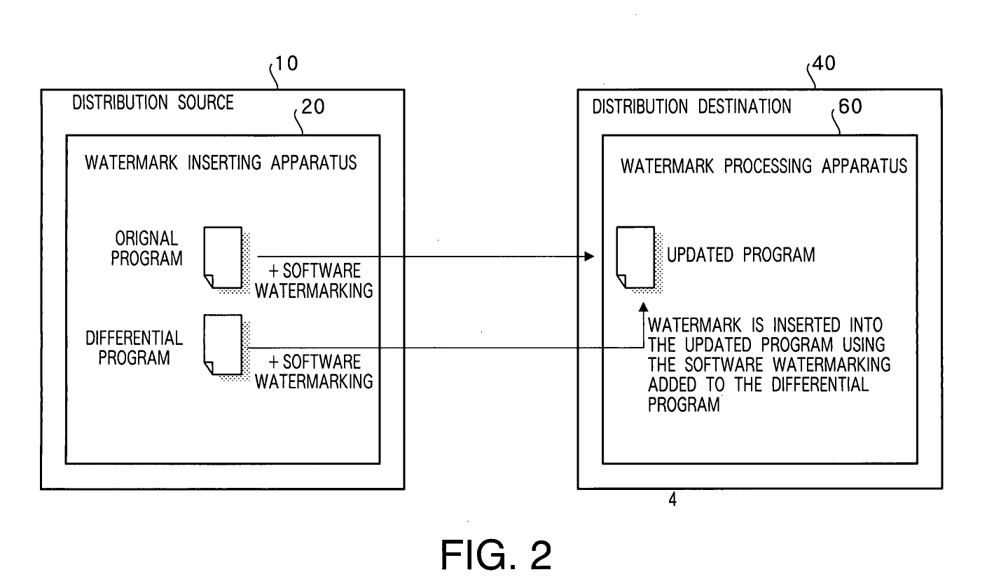

A general outline will be described below of a method of inserting a watermark into an updated program in the program unauthorized distribution prevention system according to the first embodiment. FIG. 2 is a conceptual view for illustrating the method of inserting a watermark into an updated program in the program unauthorized distribution prevention system according to the first embodiment.

In distribution source 10, watermark inserting apparatus 20 transmits an original program with a watermark and a differential program given a watermark (differential program with a watermark) to program software watermarking processing apparatus (hereinafter, referred to as a watermark processing apparatus) 60 in distribution destination 40. The differential program is, for example, a differential program obtained by Diff of UNIX(R).

In response thereto, distribution destination 40 receives the original program with the watermark and differential program with the watermark in watermark processing apparatus 60. Watermark processing apparatus 60 updates the original program with the watermark using the differential program with the watermark to generate an updated program. At this point, watermark processing apparatus 60 adds the watermark to the updated program using the watermark added to the differential program with the watermark.

In addition, before distributing a generated differential program with a watermark, the distribution source checks in advance whether the original program is updated accurately using the generated differential program with watermark. It is thereby possible to prevent update of the program software watermarking from failing in a distribution destination for a reason that the updated program does not have an area to insert the watermark.

Further, the distribution source distributes an original program such that the program recovers automatically when insertion of the watermark fails, and it is thereby possible for the distribution source to avoid a situation where the program does not operate at all when update of the watermark fails.

Thus, distribution source 10 transmits a differential program with a watermark and a distribution destination uses the watermark added to the differentia program with the watermark, whereby it is possible to readily achieve adding different watermarks for each user that uses a distributed program, while updating an original program.

In addition, when distribution destination 40 performs processing of a program software watermarking such as read, deletion and update of the program software watermarking, the destination 40 executes the processing in an area where unauthorized access is prohibited (for example, tamper-resistant device such as an IC card resistant to tamper).

By performing processing on the program software watermarking in the tamper-resistant area, it is possible to prevent unauthorized access to the program software watermarking from being caused by interpretation of a processing program of the program software watermarking and the program software watermarking from being tampered. The problem is thus overcome that insertion and/or deletion of a program software watermarking is carried out improperly.

Further, with respect to watermark insertion processing in a distribution source, it is preferable to perform the processing in a tamper-resistant area for the same reason.

Furthermore, in order to verify that a distributed program is not tampered, a digital signature is added to an original program and differential program to distribute. A distribution source or creator of a program adds a digital signature, whereby tamper in a process of distribution is detected. Before storing a program in a tamper-resistant area, by checking whether a signature is the signature of the distribution source or creator of the program, it is possible to inhibit update in a program software watermarking using an unauthorized watermark.

In addition, authentication of an authorized distribution source or program creator and authentication that update is carried out by an authorized user is resolved by using conventional techniques of terminal authentication (for example, a method using a terminal ID or PKI) and personal authentication (for example, a method using a fingerprint or iris) that are used generally.

A configuration will be described specifically below of the unauthorized distribution prevention system where the watermark insertion processing is performed on an updated program as described above.

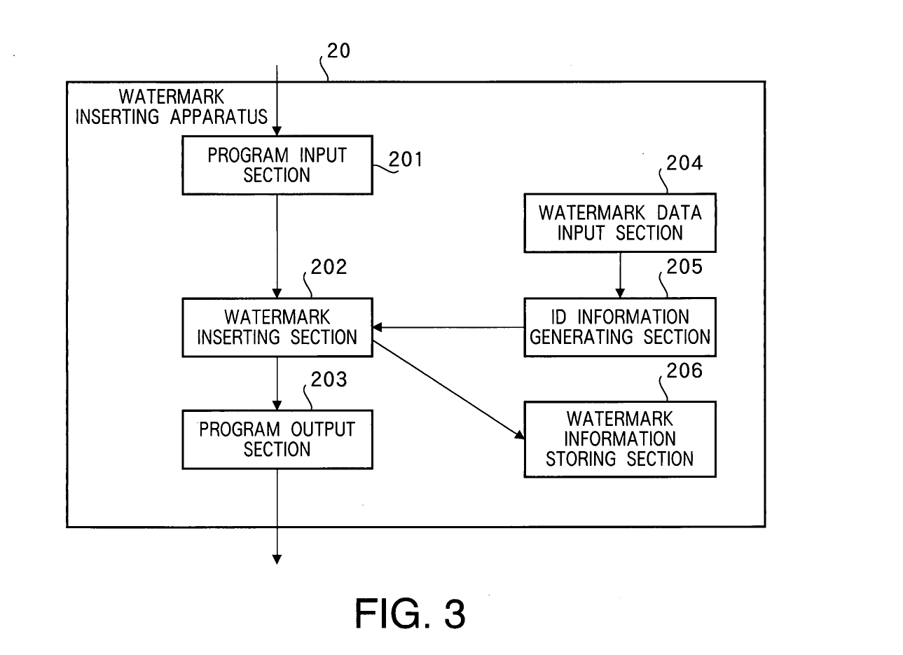

Watermark inserting apparatus 20 according to the first embodiment will be described first with reference to FIG. 3. FIG. 3 is a block diagram of watermark inserting apparatus 20.

Watermark inserting apparatus 20 is provided with program input section 201. Program input section 201 receives and inputs a transmitted original program code (hereinafter, referred to as an original program) to input a watermark and a differential program to update the original program. Program input section 201 outputs the original program and differential program to watermark inserting section 202.

In addition, a program input section that inputs an original program and a program input section that inputs a differential program may be provided separately.

Further, the original program and differential program may be stored in advance, instead of being transmitted.

Watermark inserting section 202 generates a watermark to actually embed in the original program and differential program from ID information generated in ID information generating section 205, and inputs the watermark to the original program and differential program output from program input section 201. Further, when the original program and differential program output from program input section 201 are source codes, watermark inserting section 202 compiles the source codes, and provides an input location of a watermark as a line number of an assembler code to watermark information storing section 206. In addition, the watermark insertion processing in watermark inserting section 202 will be specifically described later.

Further, a configuration is available that is provided separately with a section for inserting a watermark into an original program and a section for inserting a watermark to a differential program.

Program output section 203 transmits to distribution destination 40 the original program and differential program each with the watermark input in watermark inserting section 202.

In addition, a configuration is available that is provided separately with a section for outputting an original program with a watermark and a section for outputting a differential program with a watermark.

Watermark data input section 204 receives transmitted watermark data to input. The input watermark data is information to uniquely specify a distribution destination, and includes an address, telephone number, company name, personal name and/or e-mail address of a distribution destination and an expiration data until which the destination is allowed to use the program.

The watermark data may be input through a keyboard, instead of being transmitted.

ID information generating section 205 generates ID information that can be determined uniquely from the watermark data input from watermark data input section 204. The ID information may be input data itself or data encrypted from the input data. Further, the ID information may be an ID to uniquely specify the watermark data in a database that stores the watermark data.

In the first embodiment, the watermark information is generated based on the ID information, but it is not necessary to always generate the watermark information based on the ID information, and it is only required that a distribution destination can be specified from the watermark information. For example, watermark information and a distribution destination may be specified uniquely in such a manner that 1 to N sequence numbers are inserted into software as watermark information, and software of number i is distributed to distribution destination A, while software of number j is distributed to distribution destination B.

Watermark information storing section 206 stores an insertion location of the watermark inserted in watermark inserting section 202, and more specifically, stores an assembler code line number of the program with the watermark inserted therein.

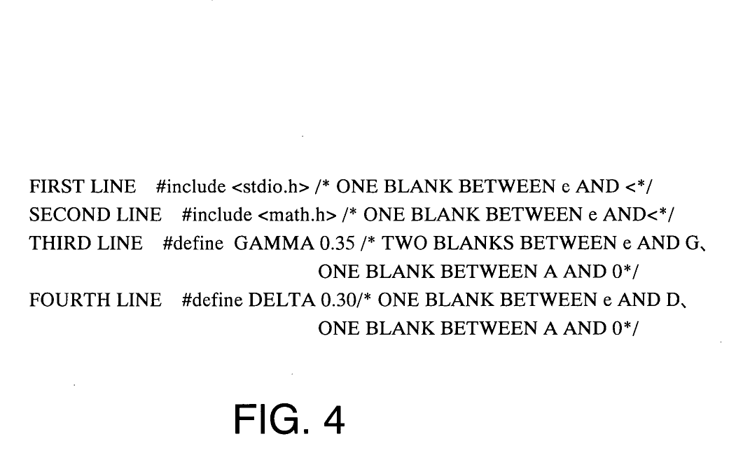

Referring to FIG. 4, processing will be described below of inserting a software watermarking into a program in watermark inserting section 202 in watermark inserting apparatus 20 according to the first embodiment. FIG. 4 is a view for illustrating a specific method of inserting a software watermarking into a program in watermark inserting section 202 in watermark inserting apparatus 20 according to the first embodiment.

In an example in FIG. 4, watermark inserting section 202 varies a space length to insert into a source code corresponding to a value of a watermark bit. Further, watermark inserting section 202 varies the space length corresponding to a line number of the source code in which the watermark bit is embedded.

Specifically, watermark inserting section 202 sets a space length to insert at 1 when a watermark bit with a value of 0 is inserted in a line of odd number, while setting a space length to insert at 2 when a watermark bit with a value of 1 is inserted in a line of odd number. Further, watermark inserting section 202 sets a space length to insert at 2 when a watermark bit with a value of 0 is inserted in a line of even number, while setting a space length to insert at 1 when a watermark bit with a value of 1 is inserted in a line number of even number.

In the example in FIG. 4, using the aforementioned role, watermark inserting section 202 inserts spaces between character symbols of from the first line to fourth line of the source code written in C language, and thus embeds a bit sequence of “011011” of the software watermarking.

In addition, it is possible to insert software watermarking information into a differential program obtained by Diff of UNIX(R), etc. by a similar method.

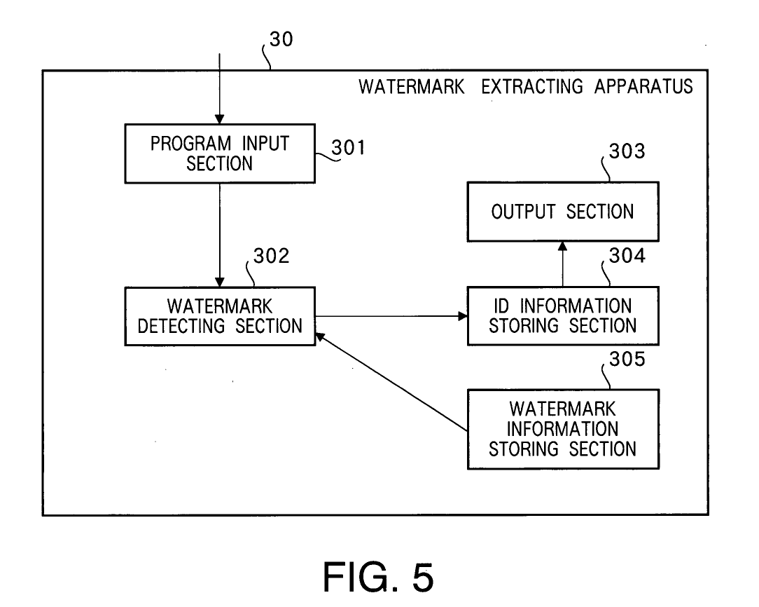

Watermark extracting apparatus 30 according to the first embodiment will be described below with reference to FIG. 5. FIG. 5 is a block diagram of watermark extracting apparatus 30 in the first embodiment.

Program input section 301 receives and inputs the original program and updated program each with the watermark inserted therein outflowed from distribution destinations 40a and 40b.

Watermark detecting section 301 deassembles the original program and updated program output from program input section 301, and extracts an input watermark from watermark insertion locations (assembler code line numbers) obtained from watermark information storing section 305. Watermark detecting section 302 generates ID information from the extracted watermark to provide to ID information storing section 304.

ID information storing section 304 generates information of a distribution destination from the ID information obtained from watermark detecting section 302. When ID information is an ID of data in a database, ID information storing section 304 extracts data from the ID and thereby acquires information of a distribution destination. Further, when ID information is encrypted data of information of a distribution destination, ID information storing section 304 decodes the data to acquire information of the distribution destination.

Watermark information storing section 305 stores watermark insertion locations of a distributed program. Information of the watermark insertion locations is obtained from watermark information storing section 206 in watermark inserting apparatus 20.

Output section 303 outputs the acquired information of the distribution destination.

Thus, watermark extracting apparatus 30 outputs information of the distribution destination from improperly distributed original program and updated program to specify distribution destination 40.

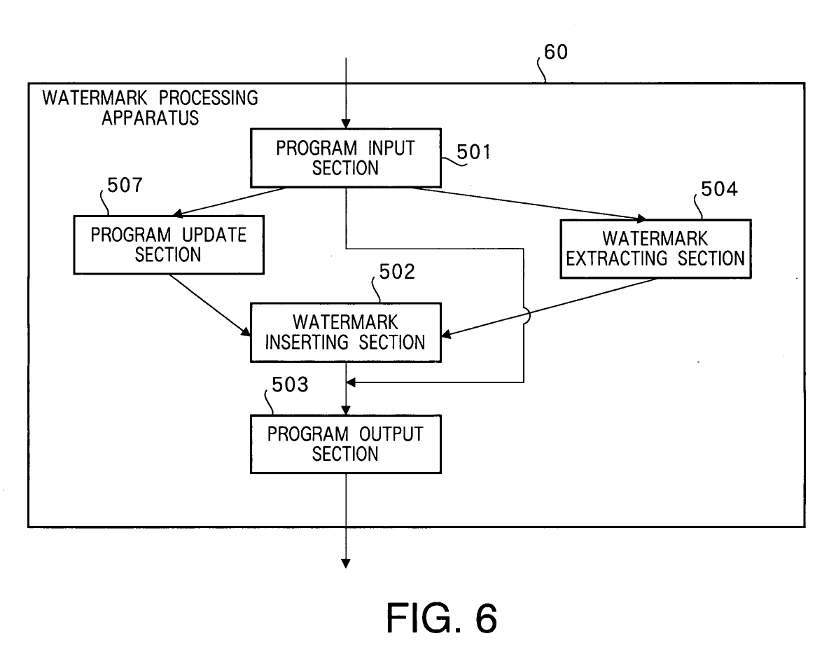

A configuration of watermark processing apparatus 60 will be described below with reference to FIG. 6. FIG. 6 is a diagram of watermark processing apparatus 60.

Watermark processing apparatus 60 is provided with program input section 501 that receives and inputs an original program with a watermark and differential program with a watermark transmitted from distribution source 10. Program input section 501 outputs the original program with the watermark to program output section 503, while outputting the differential program with the watermark to watermark extracting section 504 and program update section 507.

In addition, a configuration is available that is provided separately with a section that inputs an original program with a watermark and a section that inputs a differential program with a watermark.

Watermark processing apparatus 60 is provided with watermark extracting section 504 that extracts the watermark from the differential program with the watermark output from program input section 501. Watermark extracting section 504 outputs the extracted watermark to watermark inserting section 502.

Program update section 507 updates the original program with the watermark using the differential program with the watermark to generate an updated program, and outputs the generated updated program to watermark inserting section 502.

Watermark inserting section 502 inserts the watermark output from watermark extracting section 504 into the updated program output from program update section 507, and thereby generates the updated program with the watermark to output to program output section 503. The watermark insertion processing in watermark inserting section 502 is the same as in watermark inserting section 202.

Program output section 503 transmits to distribution source 10 the original program with the watermark output from program input section 501 and the updated program with the watermark output from watermark inserting section 502.

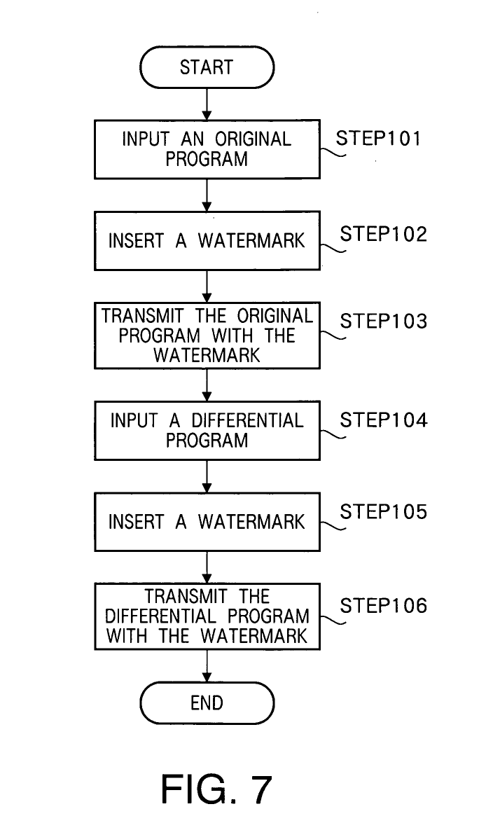

The operation of watermark inserting apparatus 20 according to the first embodiment will be described below with reference to FIG. 7. FIG. 7 is a flowchart of processing for transmitting a program in watermark inserting apparatus 20 in distribution source 10.

Watermark inserting apparatus 20 receives a transmitted original program in program input section 201 to input (step 101). Program input section 201 outputs the input original program to watermark inserting section 202.

Watermark inserting section 202 generates a watermark to embed in the original program from ID information generated in ID information generating section 205, inserts the watermark into the original program output from program input section 201, and generates the original program with the watermark (step 102). Watermark inserting section 202 outputs the original program with the watermark to program output section 203, and program output section 203 transmits the program to distribution destination 40 (step 103).

Watermark inserting apparatus 20 waits for a differential program to update the original program to be transmitted, and when the differential program is transmitted, receives the transmitted differential program in program input section 201 to input (step 104). Program input section 201 outputs the input differential program to watermark inserting section 202.

Watermark inserting section 202 generates a watermark to embed in the differential program from ID information generated in ID information generating section 205, inserts the watermark into the differential program output from program input section 201, and generates the differential program with the watermark (step 105).

In step 105, watermark inserting section 202 adds different watermarks to the differential program and original program.

Watermark inserting section 202 outputs the differential program with the watermark to program output section 203, and program output section 203 transmits the program to distribution destination 40 (step 106).

Thus, watermark inserting apparatus 20 in distribution source 10 transmits the original program with the watermark and differential program with the watermark to distribution destination 40.

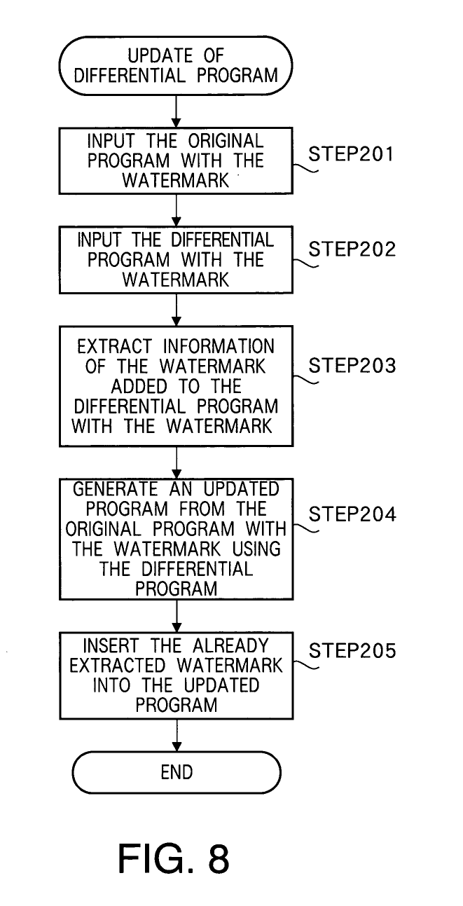

Referring to FIG. 8, the processing will be described below for generating an updated program from the original program using the differential program in distribution destination 40. FIG. 8 is a flowchart of processing for updating the original program with the watermark in watermark processing apparatus 60 in distribution destination 40.

Watermark processing apparatus 60 receives the transmitted original program with the watermark in program input section 501 to input (step 201). Program input section 501 outputs the original program with the watermark.

Watermark processing apparatus 60 waits for the differential program with the watermark to be transmitted, and when the differential program with the watermark is transmitted, receives the program in program input section 501 to input (step 202). Program input section 501 outputs the differential program with the watermark.

Watermark extracting section 504 in watermark processing apparatus 60 receives the input differential program with the watermark output from program input section 501, and extracts information of the watermark added to the input differential program with the watermark (step 203). Watermark extracting section 203 outputs the watermark extracted from the differential program with the watermark to watermark inserting section 502.

Program update section 507 in watermark processing apparatus 60 generates an updated program by updating the original program with the watermark using the differential program with the watermark, and outputs the generated updated program to watermark inserting section 502 (step 204).

Since there is a possibility that the watermark has been deleted from the updated program generated in step 204, watermark inserting section 502 inserts into the updated program the watermark that is beforehand extracted from the differential program with the watermark in watermark extracting section 504 (step 205).

Watermark processing apparatus 60 thus inserts the watermark into the updated program.

In addition, it is assumed in the first embodiment that the method of extracting a watermark from a differential program with the watermark is already known in watermark processing apparatus 60.

As described above, according to the first embodiment, it is possible to add a watermark added to a differential program with the watermark to an updated program that is generated using the differential program with the watermark. In this way, even when the watermark is deleted in generating the updated program, it is possible to reliably add the watermark to the updated program. Further, by preparing a different watermark to add to a differential program for each user, it is possible to add the different watermark for each user that uses the program. Accordingly, since it is made not possible for distribution destination 40 to distribute an updated program improperly, distribution source 10 is capable of distributing programs readily to an unspecified number of distribution destinations 40.

Further, according to the first embodiment, using a differential program with a watermark enables both update of an original program with a watermark and addition of a watermark.

Furthermore, since a watermark added to the original program with the watermark is different from a watermark added to the differential program with the watermark, distribution source 10 is capable of distinguishing between the watermark added to the original program and the watermark added to the differential program to manage. In this way, when a program outflows improperly, by analyzing a watermark of the program, distribution source 10 is capable of judging easily whether the outflowed program is an updated program or an original program.

In addition, while in the first embodiment distribution destination 40 performs processing of updating an original program and inserting a watermark, distribution source 10 may perform such processing to distribute to distribution destination 40. Further, a gateway apparatus or the like existing between distribution source 10 and distribution destination 40 may update an original program and insert a watermark.

Although the first embodiment describes a mode of one-to-one program distribution, the present invention is applicable to, for example, program distribution using digital broadcast and program distribution using multicast or broadcast on IP networks.

Further, each section in watermark inserting apparatus 20, watermark extracting apparatus 30 and watermark processing apparatus 60 does not need to exist in the same apparatus, and may be combined on networks so that a plurality of terminals performs processing.

Furthermore, it may be possible to prepare a program of processing executed by watermark inserting apparatus 20, watermark extracting apparatus 30 and watermark processing apparatus 60 to have a general computer execute the processing. In this case, distribution source 10 may transmit to distribution destination 40 a program for executing the processing of watermark processing apparatus 60 in advance before distributing a differential program.

(Second Embodiment)

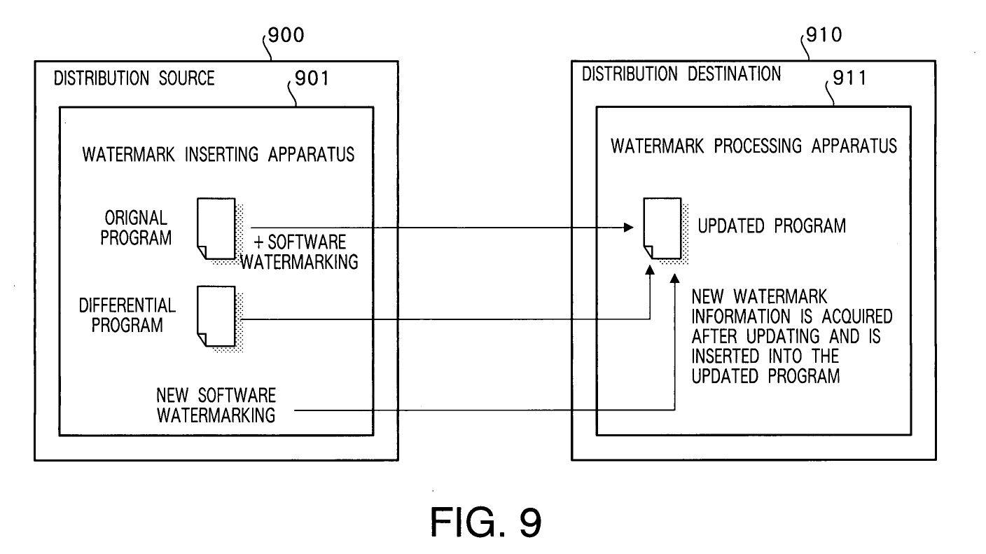

A program unauthorized distribution prevention system according to the second embodiment of the present invention will be described below. Referring to FIG. 9, a general outline will be described first of a method of inserting a watermark into an updated program in the program unauthorized distribution prevention system according to the second embodiment. FIG. 9 is a conceptual view for illustrating the method of inserting a watermark into an updated program in the program unauthorized distribution prevention system according to the second embodiment.

In the second embodiment, watermark inserting apparatus 901 in distribution source 900 transmits an original program with a watermark, a differential program and a new watermark for update to watermark processing apparatus 911 in distribution destination 910.

In response thereto, watermark processing apparatus 911 in distribution destination 910 receives the original program with the watermark, the differential program and the new watermark. Watermark processing apparatus 911 updates the original program with the watermark using the differential program to generate an updated program. Then, watermark processing apparatus 911 adds the new watermark to the updated program.

In addition, when distribution destination 910 performs processing of a program software watermarking such as read, deletion and update of the program software watermarking, the destination 910 executes the processing in an area where unauthorized access is prohibited (for example, tamper-resistant device such as an IC card resistant to tamper).

By performing processing on the program software watermarking in the tamper-resistant area, it is possible to prevent unauthorized access to the program software watermarking from being caused by interpretation of a processing program of the program software watermarking and the program software watermarking from being tampered. The problem is thus overcome that insertion and/or deletion of a program software watermarking is carried out improperly.

Further, with respect to watermark insertion processing in a distribution source, it is preferable to perform the processing in a tamper-resistant area for the same reason.

Furthermore, in order to verify that a distributed program is not tampered, a digital signature is added to an original program and differential program to distribute. A distribution source or creator of a program adds a digital signature, whereby tamper in a process of distribution is detected. Before storing a program in a tamper-resistant area, by checking whether a signature is the signature of the distribution source or creator of the program, it is possible to inhibit update of a program software watermarking using an unauthorized watermark.

In addition, authentication of an authorized distribution source or program creator and authentication that update is carried out by an authorized user is resolved by using conventional techniques of terminal authentication (for example, a method using a terminal ID or PKI) and personal authentication (for example, a method using a fingerprint or iris) that are used generally.

Thus, a watermark is added to an updated program using a new watermark.

In addition, with respect to distribution of a new software watermarking, a secure transmission path is assumed. For example, used is a secure transmission path using encryption such as SSL and IPSec. In this way, a threat is eliminated that information of a program software watermarking is tapped improperly by a third party, and is replaced with an unauthorized program software watermarking during transmission.

The program unauthorized distribution prevention system according to the second embodiment will be described below specifically.

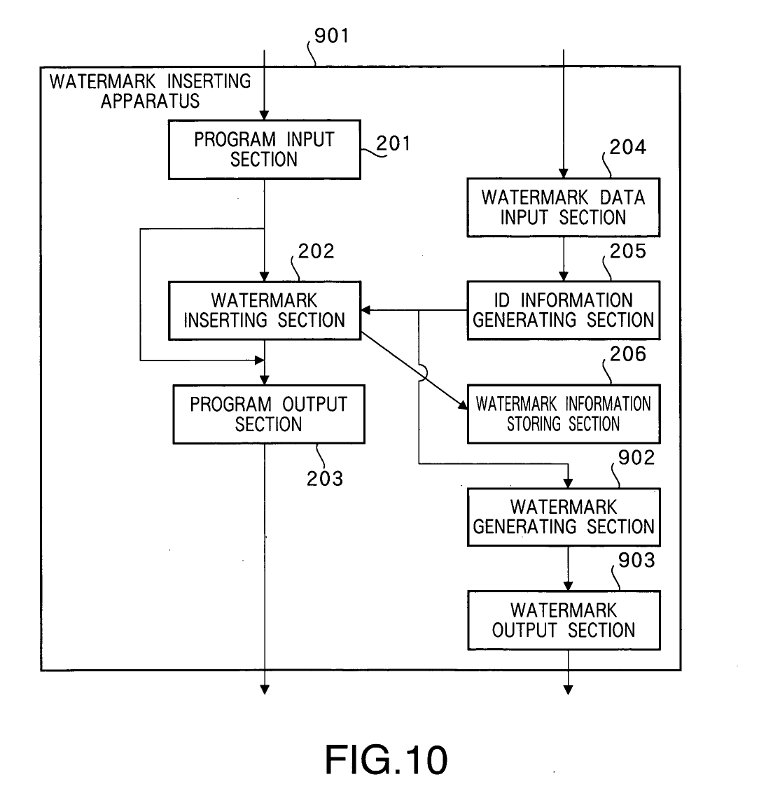

A configuration of watermark inserting apparatus 901 according to the second embodiment will be described first specifically with reference to FIG. 10. FIG. 10 is a block diagram of watermark inserting apparatus 901. In addition, the same sections as those already described are assigned the same reference numerals to omit specific descriptions thereof.

Watermark inserting apparatus 901 is provided with watermark generating section 902 that generates a watermark to actually embed in an update program from ID information generated in ID information generating section 205. Watermark generating section 902 outputs the generated watermark for the updated program to watermark output section 903, and watermark output section 903 outputs the watermark to distribution destination 910.

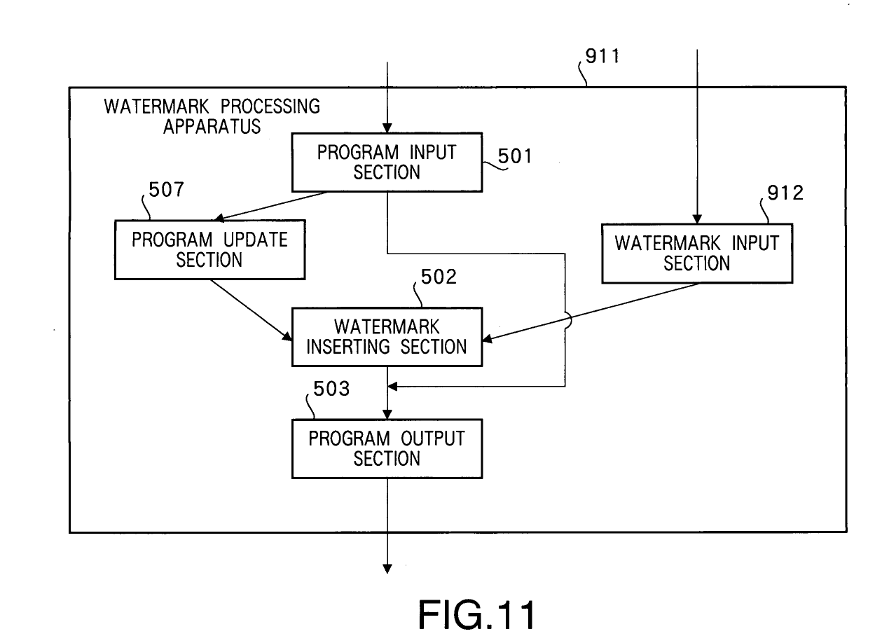

A configuration of watermark processing apparatus 911 according to the second embodiment will be described below with FIG. 11. FIG. 11 is a block diagram of watermark processing apparatus 911. In addition, the same sections as those already described are assigned the same reference numerals to omit specific descriptions thereof.

Watermark processing apparatus 911 is provided with watermark input section 912. Watermark input section 912 receives as its input a watermark transmitted from distribution source 900 to output to watermark inserting section 502.

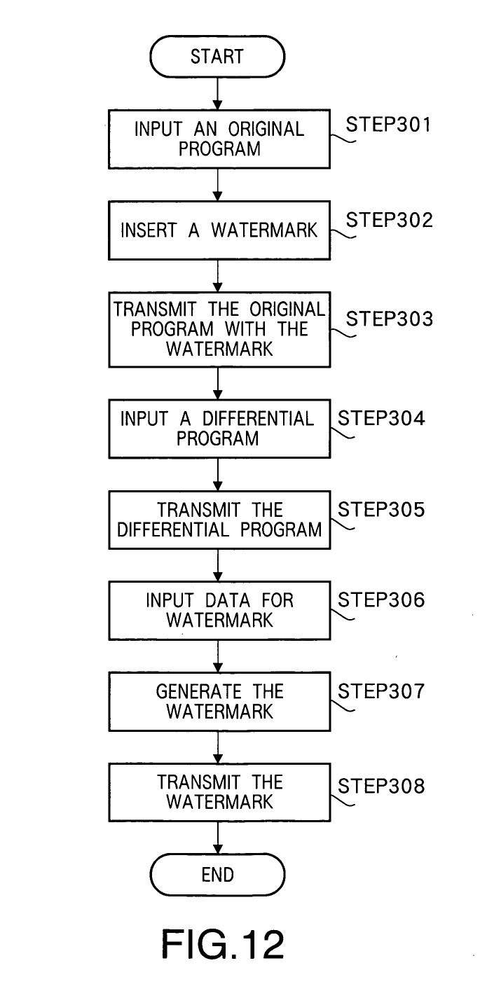

The operation of watermark inserting apparatus 901 according to the second embodiment will be described below with reference to FIG. 12. FIG. 12 is a flowchart of processing for transmitting a program in watermark inserting apparatus 901 in distribution source 900.

Watermark inserting apparatus 901 receives a transmitted original program in program input section 201 to input (step 301). Program input section 201 outputs the input original program to watermark inserting section 202.

Watermark inserting section 202 generates a watermark to embed in the original program from ID information generated in ID information generating section 205, inserts the watermark into the original program output from program input section 201, and generates the original program with the watermark (step 302). Watermark inserting section 202 outputs the original program with the watermark to program output section 203, and program output section 203 transmits the program to distribution destination 910 (step 303).

Watermark inserting apparatus 901 waits for a differential program to update the original program to be transmitted, and when the differential program is transmitted, receives the transmitted differential program in program input section 201 to input (step 304). Program input section 201 outputs the input differential program to program output section 203, and program output section 203 transmits the program to distribution destination 910 (step 305).

Watermark inserting apparatus 901 waits for data of a new watermark to be transmitted, and when the data is transmitted, receives the data in watermark data input section 204 to input (step 306). Watermark data input section 204 outputs the data for the new watermark to ID information generating section 205.

ID information generating section 205 generates ID information from the data for the new watermark to output to watermark generating section 902 (step 307).

Watermark generating section 902 generates a new watermark from the data for the new watermark to output to watermark output section 903 (step 307).

Watermark output section 903 transmits the new watermark to distribution destination 910 (step 308).

Thus, watermark inserting apparatus 901 in distribution source 900 transmits the original program with the watermark, differential program and new watermark to distribution destination 910.

In addition, when a new watermark is transmitted, used is a transmission path where security is ensured.

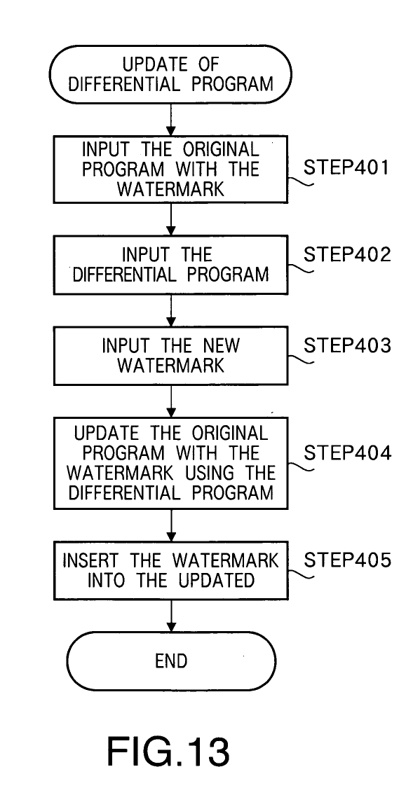

Referring to FIG. 13, the processing will be described below for generating an updated program with a watermark from the original program using the differential program and new watermark in distribution destination 910. FIG. 13 is a flowchart of processing for updating the original program with the watermark in watermark processing apparatus 911 in distribution destination 910.

Watermark processing apparatus 911 receives the transmitted original program with the watermark in program input section 501 to input (step 401). Program input section 501 outputs the original program with the watermark.

Watermark processing apparatus 911 waits for the differential program to be transmitted, and when the differential program is transmitted, receives the program in program input section 501 to input (step 402). Program input section 501 outputs the differential program.

Watermark processing apparatus 911 waits for the new watermark to be transmitted, and when the new watermark is transmitted, receives the watermark in watermark input section 912 to input (step 403). Watermark input section 912 outputs the new watermark to watermark inserting section 502.

Program update section 507 in watermark processing apparatus 911 generates an updated program by updating the original program with the watermark output from program input section 501 using the differential program, and outputs the generated updated program to watermark inserting section 502 (step 404).

Since there is a possibility that the watermark has been deleted from the updated program generated in step 404, watermark inserting section 502 inserts into the updated program the new watermark output from watermark input section 912 (step 405).

Watermark processing apparatus 911 thus inserts the watermark into the updated program.

As described above, according to the second embodiment, using a new watermark enables the watermark to be added to an updated program. Further, by varying new watermarks with users, it is possible to add a different watermark to each user that uses the program.

Further, according to the second embodiment, distribution destination 910 does not need to generate or extract a watermark, thereby simplifying a configuration of distribution destination 910.

Furthermore, since a watermark and a differential program are independent, it is possible to use a common differential program for a plurality of users.

Moreover, in the second embodiment, distribution source 900 may have the function of authenticating a user of distribution destination 910 and the function of charging. By this means, distribution source 900 allows update of an original program only when a watermark is used, issues a watermark only to distribution destination 910 that pays a charge and performs registration to update an original program, and thus permits only the distribution destination 910 that pays a charge and performs registration to update an original program.

Further, such service may be provided that distribution source 900 generates an updated program in advance, and distribution destination 910 purchases a watermark when the updated program is needed, adds the watermark to the updated program, and thus is allowed to use the updated program.

Furthermore, each section in watermark inserting apparatus 901 and watermark processing apparatus 911 does not need to exist in the same apparatus, and maybe combined on networks so that a plurality of terminals performs processing.

Moreover, it may be possible to prepare a program of processing executed by watermark inserting apparatus 901 and watermark processing apparatus 911 to have a general computer execute the processing.

(Third Embodiment)

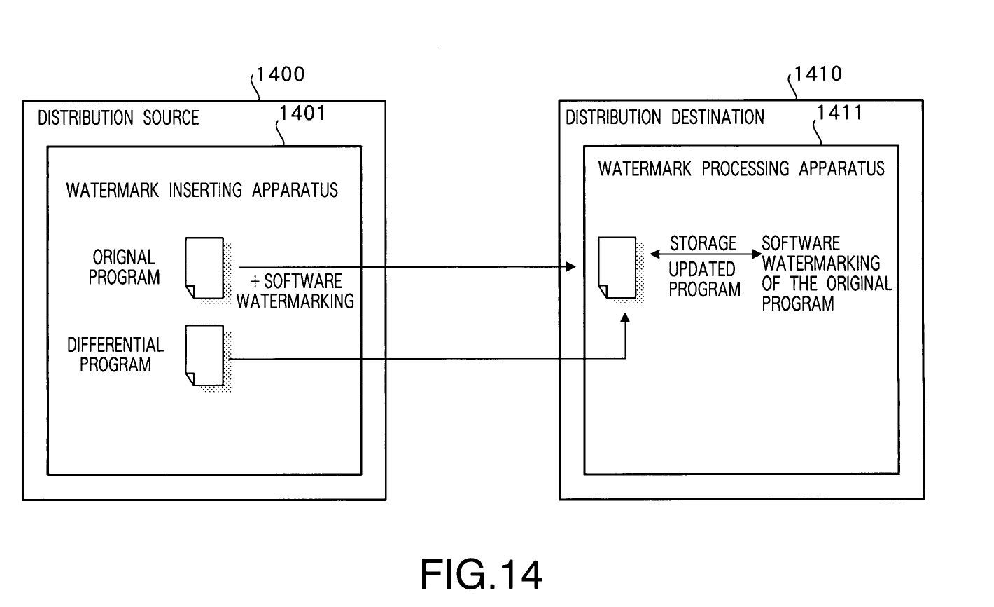

A program unauthorized distribution prevention system according to the third embodiment of the present invention will be described below. Referring to FIG. 14, a general outline will be described first of a method of inserting a watermark into an updated program in the program unauthorized distribution prevention system according to the third embodiment. FIG. 14 is a conceptual view for illustrating the method of inserting a watermark into an updated program in the program unauthorized distribution prevention system according to the third embodiment.

In the third embodiment, watermark inserting apparatus 1401 in distribution source 1400 transmits an original program with a watermark and a differential program to watermark processing apparatus 1411 in distribution destination 1410.

In response thereto, watermark processing apparatus 1411 in distribution destination 1410 receives the original program with the watermark and differential program. Watermark processing apparatus 1411 extracts the watermark from the original program with the watermark. Watermark processing apparatus 1411 updates the original program with the watermark using the differential program to generate an updated program. Then, watermark processing apparatus 1411 adds the watermark extracted from the original program with the watermark to the updated program.

In addition, when distribution destination 1410 performs processing of a program software watermarking such as read, deletion and update of the program software watermarking, the destination 1410 executes the processing in an area where unauthorized access is prohibited (for example, tamper-resistant device such as an IC card resistant to tamper).

By performing processing on the program software watermarking in the tamper-resistant area, it is possible to prevent unauthorized access to the program software watermarking from being caused by interpretation of a processing program of the program software watermarking and the program software watermarking from being tampered. The problem is thus overcome that insertion and/or deletion of a program software watermarking is carried out improperly.

Further, with respect to watermark insertion processing in a distribution source, it is preferable to perform the processing in a tamper-resistant area for the same reason.

Furthermore, in order to verify that a distributed program is not tampered, a digital signature is added to an original program and differential program to distribute. A distribution source or creator of a program adds a digital signature, whereby tamper in a process of distribution is detected. Before storing a program in a tamper-resistant area, by checking whether a signature is the signature of the distribution source or creator of the program, it is possible to inhibit update of a program software watermarking using an unauthorized watermark.

In addition, authentication of an authorized distribution source or program creator and authentication that update is carried out by an authorized user is resolved by using conventional techniques of terminal authentication (for example, a method using a terminal ID or PKI) and personal authentication (for example, a method using a fingerprint or iris) that are used generally.

Thus, a watermark is added to an updated program using the watermark added to the original program with the watermark.

The program unauthorized distribution prevention system according to the third embodiment will be described below specifically.

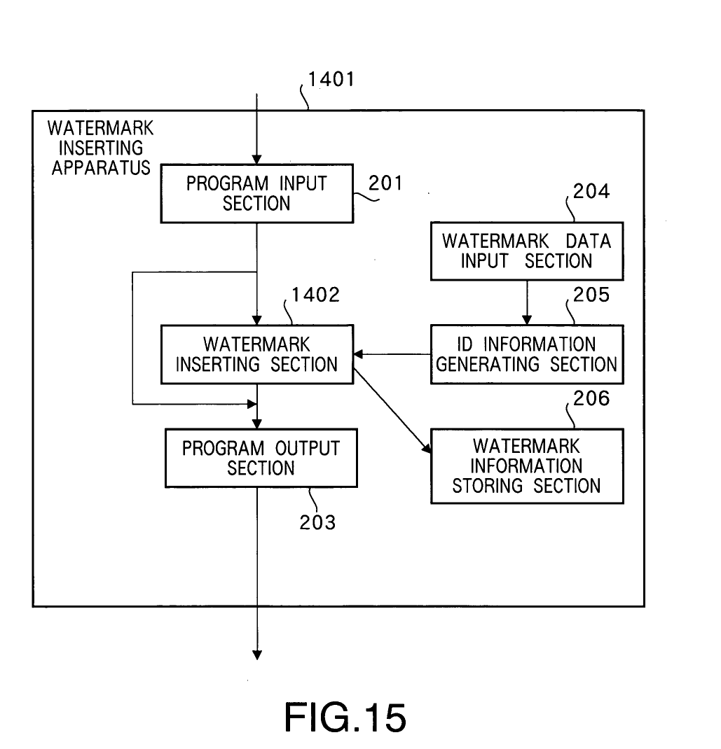

A configuration of watermark inserting apparatus 1401 according to the third embodiment will be described first specifically with reference to FIG. 15. FIG. 15 is a block diagram of watermark inserting apparatus 1401. In addition, the same sections as those already described are assigned the same reference numerals to omit specific descriptions thereof.

Watermark inserting section 1402 in watermark inserting apparatus 1401 generates a watermark using ID information output from ID information generating section 205, and adds the watermark to the original program output from program input section 201.

Meanwhile, watermark inserting section 1402 does not receive the differential program output from program input section 201 nor performs any processing thereon.

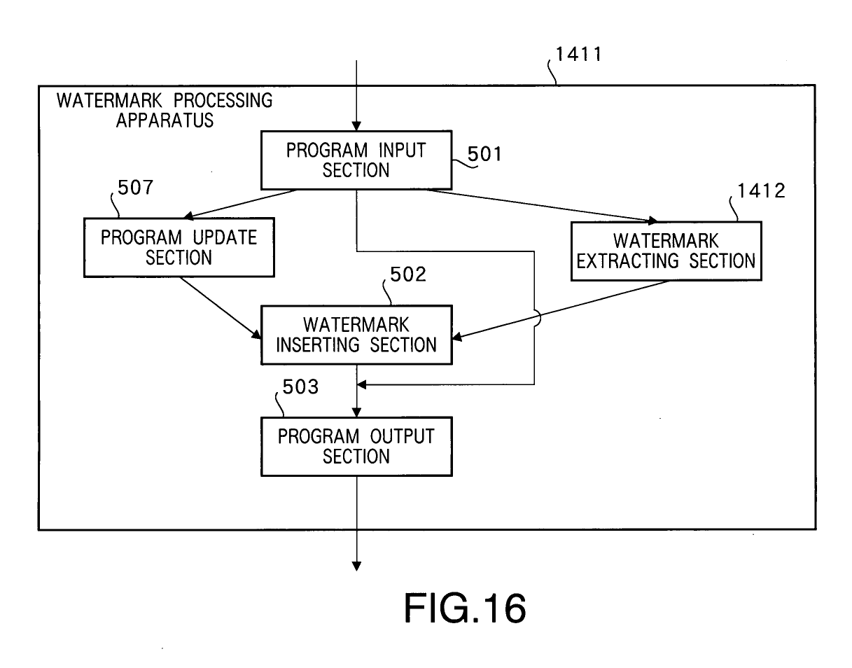

A configuration of watermark processing apparatus 1411 according to the third embodiment will be described below specifically with reference to FIG. 16. FIG. 16 is a block diagram of watermark inserting apparatus 1411. In addition, the same sections as those already described are assigned the same reference numerals to omit specific descriptions thereof.

Watermark processing apparatus 1411 is provided with watermark extracting section 1412 that extracts the watermark from the original program with the watermark output from program input section 501. Watermark extracting section 1412 outputs the extracted watermark to watermark inserting section 502.

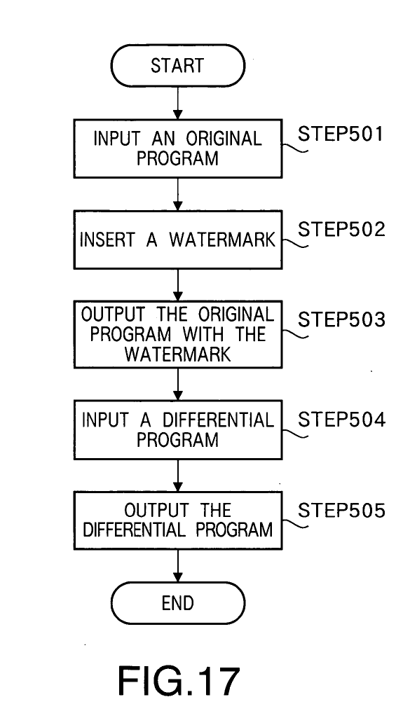

The operation of watermark inserting apparatus 1401 according to the third embodiment will be described below with reference to FIG. 17. FIG. 17 is a flowchart of processing for transmitting a program in watermark inserting apparatus 1401 in distribution source 1400.

Watermark inserting apparatus 1401 receives a transmitted original program in program input section 201 to input (step 501). Program input section 201 outputs the input original program to watermark inserting section 1402.

Watermark inserting section 1402 generates a watermark to embed in the original program from ID information generated in ID information generating section 205, inserts the watermark into the original program output from program input section 201, and generates the original program with the watermark (step 502). Watermark inserting section 1402 outputs the original program with the watermark to program output section 203, and program output section 203 transmits the program to distribution destination 1410 (step 503).

Watermark inserting apparatus 1401 waits for a differential program to update the original program to be transmitted, and when the differential program is transmitted, receives the transmitted differential program in program input section 201 to input (step 504). Program input section 201 outputs the input differential program to program output section 203, and program output section 203 transmits the differential program to distribution destination 1410 (step 505).

Thus, watermark inserting apparatus 1401 in distribution source 1400 transmits the original program with the watermark and differential program to distribution destination 1410.

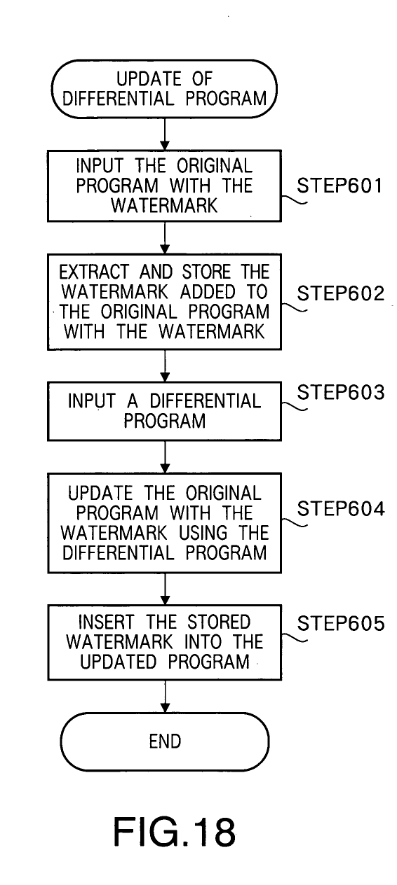

Referring to FIG. 18, the processing will be described below for generating an updated program from the original program using the differential program in distribution destination 1410. FIG. 18 is a flowchart of processing for updating the original program with the watermark in watermark processing apparatus 1411 in distribution destination 1410.

Watermark processing apparatus 1411 receives the transmitted original program with the watermark in program input section 501 to input (step 601). Program input section 501 outputs the original program with the watermark.

Watermark extracting section 1412 in watermark processing apparatus 1411 receives the original program with the watermark output form program input section 501, and extracts information of the watermark added to the input original program with the watermark to store (step 602).

Watermark processing apparatus 1411 waits for the differential program to be transmitted, and when the differential program is transmitted, receives the program in program input section 501 to input (step 603). Program input section 501 outputs the differential program.

Program update section 507 in watermark processing apparatus 1411 generates an updated program by updating the original program with the watermark using the differential program, and outputs the updated program to watermark inserting section 502 (step 604).

Since there is a possibility that the watermark has been deleted from the updated program generated in step 604, watermark inserting section 502 inserts into the updated program the watermark that is beforehand extracted from the original program with the watermark in watermark extracting section 1412 (step 605).

Watermark processing apparatus 1411 thus inserts the watermark into the updated program.

As described above, according to the third embodiment, a watermark added to an original program with the watermark is extracted and stored, and the extracted watermark is used again as a watermark for the updated program and added to the updated program.

Further, according to the third embodiment, since the watermark added to the original program can be used permanently, it is possible to reduce management cost (the content of issue of program software watermarking) of a manager of copyright.

Furthermore, each section in watermark inserting apparatus 14010 and watermark processing apparatus 1411 does not need to exist in the same apparatus, and may be combined on networks so that a plurality of terminals performs processing.

Moreover, it may be possible to prepare a program of processing executed by watermark inserting apparatus 1401 and watermark processing apparatus 1411 to have a general computer execute the processing.

(Fourth Embodiment)

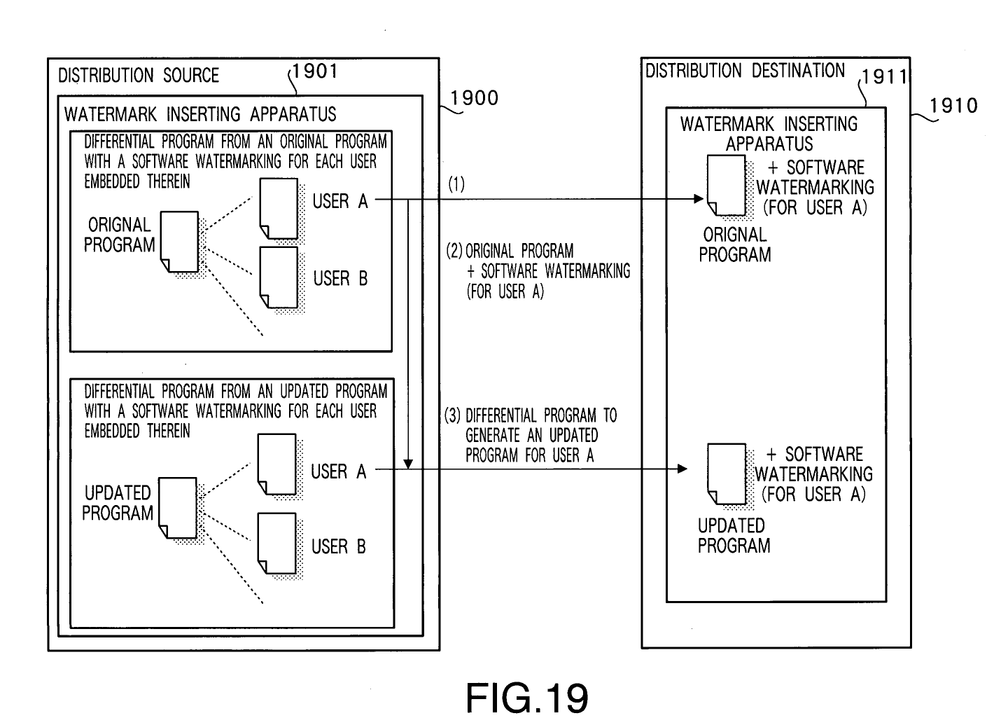

A program unauthorized distribution prevention system according to the fourth embodiment of the present invention will be described below. A general outline of processing in the program unauthorized distribution prevention system according to the fourth embodiment will be described first with reference to FIG. 19. FIG. 19 is a conceptual view for illustrating the processing in the program unauthorized distribution prevention system according to the fourth embodiment.

Watermark inserting apparatus 1901 in distribution source 1900 generates an original program with a watermark using the original program to transmit to distribution destination 1910. The watermark added to the original program with the watermark varies with each distribution destination 1910 (user). In other words, watermark inserting apparatus 1902 generates original programs with different watermarks between distribution destinations 1910 to transmit for each distribution destination 1910.

Watermark inserting apparatus 1901 generates a differential program (original-management differential program) of the original program and the original programs with the watermark. Since the original programs with the watermarks are different between users, watermark inserting apparatus 1901 manages original-management differential programs differing between the users.

Watermark inserting apparatus generates an updated program by updating the original program using an update differential program. Watermark inserting apparatus 1901 generates a differential program (updated-management differential program) of the updated program and the updated program with the watermark to manage. Since updated programs with the watermarks are different between users, watermark inserting apparatus 1901 manages updated-management differential programs differing between the users.

In addition, before distributing a generated differential program with the watermark, the distribution source checks in advance whether the original program is updated accurately using the generated differential program with watermark. It is thereby possible to prevent update of the program software watermarking from failing in a distribution destination for a reason that the updated program does not have an area to insert the watermark.

Further, the distribution source distributes an original program such that the program recovers when insertion of the watermark fails, and it is thereby possible for the distribution source to avoid a situation where the program does not operate at all when update of the watermark fails.

Watermark inserting apparatus 1901 generates a differential program (user differential program) to generate an updated program with a watermark from the original program with the watermark to transmit, using the original-management differential program and updated-management differential program.

Meanwhile, distribution destination 1910 receives the original program with the watermark in watermark processing apparatus 1911.

Further, watermark processing apparatus 1911 receives the user differential program, and using the differential program, generates an updated program with a watermark.

Thus, a watermark is added to the updated program in the program unauthorized distribution prevention system according to the fourth embodiment.

In addition, when distribution destination 1910 performs processing of a program software watermarking such as read, deletion and update of the program software watermarking, the destination 1910 executes the processing in an area where unauthorized access is prohibited (for example, tamper-resistant device such as an IC card resistant to tamper).

By performing processing on the program software watermarking in the tamper-resistant area, it is possible to prevent unauthorized access to the program software watermarking from being caused by interpretation of a processing program of the program software watermarking and the program software watermarking from being tampered. The problem is thus overcome that insertion and/or deletion of a program software watermarking is carried out improperly.

Further, with respect to watermark insertion processing in a distribution source, it is preferable to perform the processing in a tamper-resistant area for the same reason.

Furthermore, in order to verify that a distributed program is not tampered, a digital signature is added to an original program and differential program to distribute. A distribution source or creator of a program adds a digital signature, whereby tamper in a process of distribution is detected. Before storing a program in a tamper-resistant area, by checking whether a signature is the signature of the distribution source or creator of the program, it is possible to inhibit update of a program software watermarking using an unauthorized watermark.

In addition, authentication of an authorized distribution source or program creator and authentication that update is carried out by an authorized user is resolved by using conventional techniques of terminal authentication (for example, a method using a terminal ID or PKI) and personal authentication (for example, a method using a fingerprint or iris) that are used generally.

The program unauthorized distribution prevention system according to the fourth embodiment will be described below specifically.

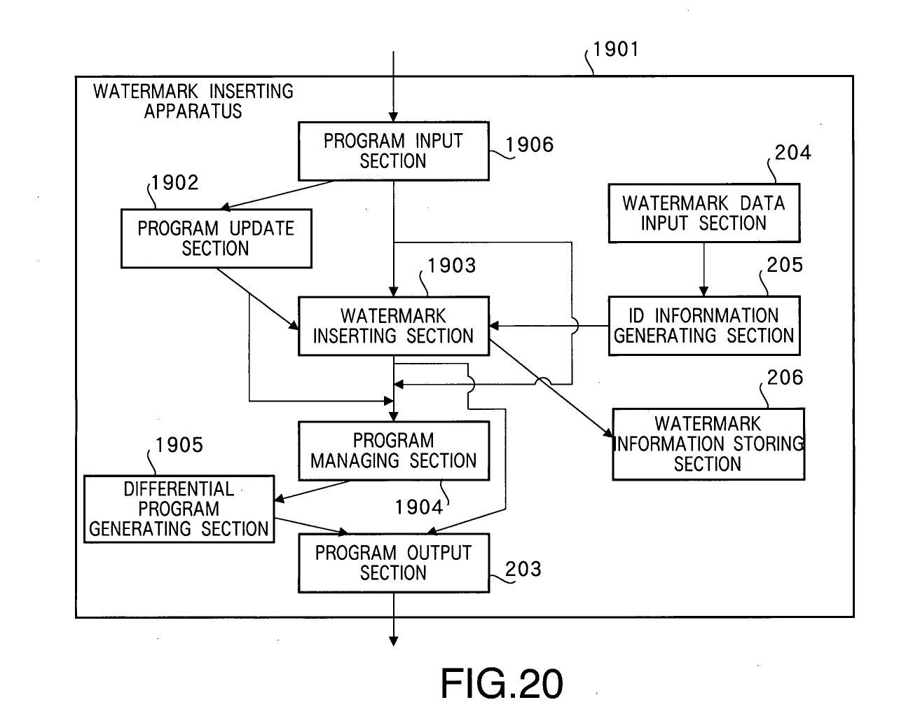

A configuration of watermark inserting apparatus 1901 according to the fourth embodiment will be described first specifically with reference to FIG. 20. FIG. 20 is a block diagram of watermark inserting apparatus 1901. In addition, the same sections as those already described are assigned the same reference numerals to omit specific descriptions thereof.

Watermark inserting apparatus 1901 is provided with program input section 1906 that receives and inputs the original program and differential program to update the original program.

Watermark inserting apparatus 1901 is provided with program update section 1902 that generates an updated program by updating the original program using the differential program to output.

Watermark inserting apparatus 1901 is provided with watermark inserting section 1903 that generates a watermark from ID information output from ID information generating section 205 to insert into the original program and updated program.

Watermark inserting apparatus 1901 is provided with program managing section 1904 that generates an original-management differential program that is a differential between the original program output from program input section 1906 and the original program with the watermark output from watermark inserting section 1903 to manage.

Program managing section 1904 further manages an updated-management differential program that is a differential between the updated program output from program update section 1902 and the updated program with watermark output from watermark inserting section 1903 to manage.

Watermark inserting apparatus 1901 is provided with differential program generating section 1905 that generates a differential program (user differential program) to generate an updated program with a watermark from the original program with the watermark to transmit, using the original-management differential program and updated-management differential program that program managing section 1904 manages.

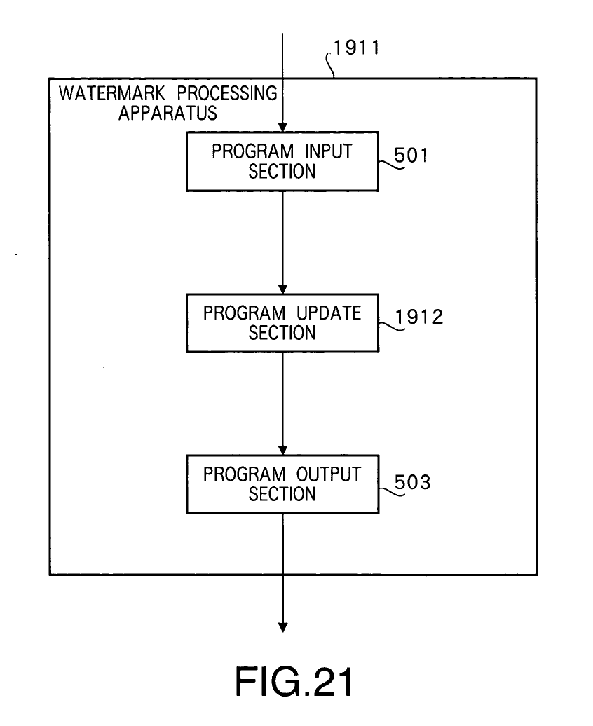

A configuration of watermark processing apparatus 1911 according to the fourth embodiment will be described first specifically with reference to FIG. 21. FIG. 21 is a block diagram of watermark processing apparatus 1911. In addition, the same sections as those already described are assigned the same reference numerals to omit specific descriptions thereof.

Watermark processing apparatus 1911 is provided with program update section 1912 that generates an updated program with a watermark by updating the original program with the watermark using the user differential program.

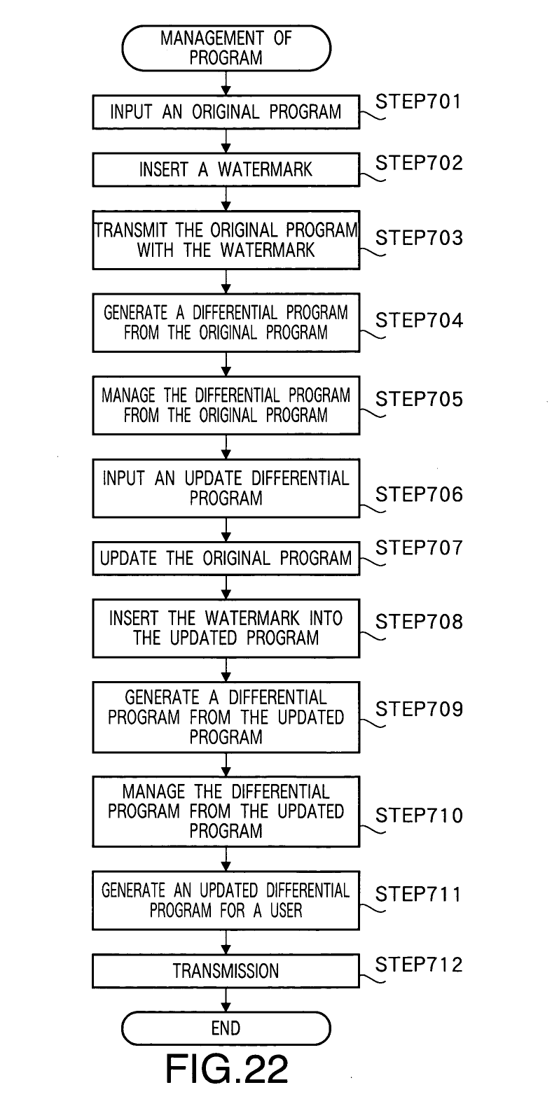

The operation of watermark inserting apparatus 1901 according to the fourth embodiment will be described below with reference to FIG. 22. FIG. 22 is a flowchart of processing in watermark inserting apparatus 1901 in distribution source 1900.

Watermark inserting apparatus 1901 receives a transmitted original program in program input section 1906 to input (step 701). Program input section 1906 outputs the input original program to watermark inserting section 1903.

Watermark inserting section 1903 generates a watermark to embed in the original program from ID information generated in ID information generating section 205, inserts the watermark into the original program output from program input section 1906, and generates the original program with the watermark (step 702). Watermark inserting section 1903 outputs the original program with the watermark to program output section 203, and program output section 203 transmits the program to distribution destination 1910 (step 703).

Watermark inserting apparatus 1901 shifts to processing of managing the original program with the watermark.

Program managing section 1904 in watermark inserting apparatus 1901 receives the original program output from program input section 1906 and the original program with the watermark output from watermark inserting section 1903. Then, program managing section 1904 obtains a differential between the original program and the original program with the watermark, and generates the original-management differential program (step 704).

Program managing section 1904 manages the generated original-management differential program (step 705).

Since a watermark to add to an original program for the original program with the watermark varies with each distribution destination 1910 (user), the original program with the watermark also varies with each distribution destination 1910. Accordingly, program managing section 1904 manages original-management differential programs differing between distribution destinations 1910.

Thus, instead of storing and managing original programs with watermarks differing between users, program managing section 1904 manages the original-management differential programs differing between the users, and it is thereby possible to reduce the capacity of a disk.

Watermark inserting apparatus 1901 shifts to processing of updating the original program.

Watermark inserting apparatus 1901 waits for an update differential program to update the original program to be transmitted, and when the differential program is transmitted, receives the differential program in program input section 1906 to input (step 706). Program input section 1906 outputs the input update differential program to watermark inserting section 1902.

Program update section 1902 generates an updated program by updating the original program beforehand output from program input section 1906 using the update differential program currently output from program input section 1906 to output (step 707).

Watermark inserting section 1903 receives the updated program generated in step 707, generates a watermark for the updated program from ID information generated in ID information generating section 205, inserts the watermark into the updated program, generates the updated program with the watermark (step 708), and outputs the generated updated program with the watermark.

Watermark inserting apparatus 1901 shifts to processing of managing the updated program with the watermark.

Program managing section 1904 in watermark inserting apparatus 1901 receives the updated program output from program update section 1902 and the updated program with the watermark output from watermark inserting section 1903. Then, program managing section 1904 obtains a differential between the updated program and the updated program with the watermark, and generates the updated-management differential program (step 709).

Program managing section 1904 manages the generated updated-management differential program (step 710).

Since a watermark to add to an updated program for the updated program with the watermark varies with each distribution destination 1910 (user), the updated program with the watermark also varies with each distribution destination 1910. Accordingly, program managing section 1904 manages updated-management differential programs differing between distribution destinations 1910.

Thus, instead of storing and managing updated programs with watermarks differing between users, program managing section 1904 manages the updated-management differential programs differing between the users, and it is thereby possible to reduce the capacity of a disk.

Watermark inserting apparatus 1901 shifts to processing for generating a program for update (user update program) of the original data with the watermark transmitted to distribution destination 1910.

Differential program generating section 1905 in watermark inserting apparatus 1901 receives the original-management differential program and updated-management differential program that program managing section 1904 manages. Then, differential program generating section 1905 generates a differential program (user differential program) to generate an updated program with a watermark from the original program with the watermark (step 711), and transmits the program to distribution destination 1910 (step 712).

Thus, watermark inserting apparatus 1901 transmits the original program with the watermark, and the user differential program to generate the updated program with the watermark from the original program with the watermark to distribution destination 1910.

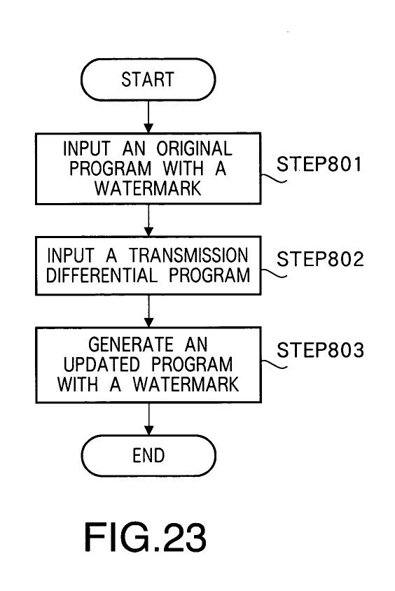

The processing in watermark processing apparatus 1911 will be described below with reference to FIG. 23. FIG. 23 is a flowchart of the processing in watermark processing apparatus 1911 in distribution destination 1910.

Watermark processing apparatus 1911 receives the transmitted original program with the watermark in program input section 501 to input (step 801). Program input section 501 outputs the original program with the watermark.

Watermark processing apparatus 1911 waits for a user differential program to update the original program with the watermark to be transmitted, and when the differential program is transmitted, receives the program in program input section 501 to input (step 802). Program input section 501 outputs the input user differential program.

Program update section 1912 generates an updated program by updating the original program with the watermark output from program input section 501 using the user differential program (step 803).

Thus, watermark processing apparatus 1911 generates the updated program with the watermark.

As described above, according to the fourth embodiment, it is possible to generate an updated program with a watermark from the original program with the watermark, using a user differential program to generate the updated program with the watermark from the original program with watermark.

Further, according to the fourth embodiment, instead of storing and managing original programs with watermarks differing between users, by managing the original-management differential programs differing between the users, it is possible to reduce the capacity of a disk.

Furthermore, according to the fourth embodiment, instead of storing and managing updated programs with watermarks differing between users, by managing the updated-management differential programs differing between the users, it is possible to reduce the capacity of a disk.

In addition, each section in watermark inserting apparatus 1901 and watermark processing apparatus 1911 does not need to exist in the same apparatus, and may be combined on networks so that a plurality of terminals performs processing.

Moreover, it may be possible to prepare a program of processing executed by watermark inserting apparatus 1901 and watermark processing apparatus 1911 to have a general computer execute the processing.

As described above, according to the present invention, since it is possible to add a watermark to an updated program obtained by updating the original program, it is possible to prevent unauthorized processing for reading, inserting, and/or deleting a software watermarking of a program from being carried out while updating the program in security, even when the program is updated. Further, the present invention is applicable in a wide range including distribution of computer program using networks.

The present invention is not limited to the above described embodiments, and various variations and modifications may be possible without departing from the scope of the present invention.

This application is based on the Japanese Patent Application No. 2003-108320 filed on Apr. 11, 2003, entire content of which is expressly incorporated by reference herein.

What is claimed is:

1. A program software watermarking processing apparatus comprising:
an original program input section that inputs an original program with a software watermarking;
a differential program input section that inputs a differential program with a software watermarking to update the original program;
a software watermarking extracting section that extracts the software watermarking from the differential program with the software watermarking;
a program update section that generates an updated program by updating the original program using the differential program with the watermark; and
a watermark inserting section that inserts the software watermarking extracted from the differential program into the updated program.

2. A program software watermarking processing apparatus comprising:
an original program input section that inputs an original program with a software watermarking;
a differential program input section that inputs a differential program to update the original program;
a watermark input section that inputs a new software watermarking;
a program update section that generates an updated program by updating the original program using the differential program; and
a watermark inserting section that inserts the new software watermarking into the updated program.

3. A program software watermarking processing apparatus comprising:
an original program input section that inputs an original program with a software watermarking;
a differential program input section that inputs a differential program to update the original program;
a software watermarking extracting section that extracts the software watermarking from the original program;
a program update section that generates an updated program by updating the original program using the differential program; and
a watermark inserting section that inserts the software watermarking extracted from the original program into the updated program.

4. A program software watermarking processing apparatus comprising:
an original program input section that inputs an original program with a software watermarking;
a differential program input section that inputs a user differential program to generate an updated program with a software watermarking from the original program with the software watermarking; and
a program update section that generates the updated program with the software watermarking from the original program with the software watermarking using the user differential program.

5. A program software watermarking inserting apparatus comprising:
an original program input section that inputs an original program;
an original watermark inserting section that adds a software watermarking to the original program to generate the original program with the watermark;
an original program output section that transmits the original program with the watermark;
a differential program input section that inputs a differential program to update the original program;
a differential program watermark inserting section that inserts a software watermarking into the differential program to generate the differential program with the watermark; and
a differential program output section that transmits the differential program with the watermark.

6. The program software watermarking inserting apparatus according to claim 5, where the software watermarking to insert into the differential program is different from the software watermarking to add to the original program.

7. A program software watermarking inserting apparatus comprising:
an original program input section that inputs an original program;
a watermark inserting section that adds a software watermarking to the original program to generate the original program with the software watermarking;
an original program output section that transmits the original program with the watermark;
a differential program input section that inputs an update differential program to update the original program;
a program update section that generates an updated program by updating the original program using the update differential program;
a watermark inserting section that inserts a software watermarking into the updated program to generate the updated program with the software watermarking;
a differential program generating section that generates a user differential program to generate the updated program with the watermark from the original program with the watermark; and
a differential program transmitting section that transmits the user differential program.

8. The program software watermarking inserting apparatus according to claim 7, further comprising:
a program managing section that generates a differential program between the original program and the original program with the watermark to manage.

9. The program software watermarking inserting apparatus according to claim 7, further comprising:
a program managing section that generates a differential program between the updated program and the updated program with the watermark to manage.

10. A program unauthorized distribution prevention system comprising:
a program software watermarking inserting apparatus having:
an original program input section that inputs an original program;
an original watermark inserting section that adds a software watermarking to the original program to generate the original program with the software watermarking;
an original program output section that transmits the original program with the software watermarking;
a differential program input section that inputs a differential program to update the original program;
a differential program watermark inserting section that inserts a software watermarking into the differential program to generate the differential program with the software watermarking; and
a differential program output section that transmits the differential program with electronic the watermark,
and a program software watermarking processing apparatus having:
an original program input section that inputs the original program with the software watermarking;
a differential program input section that inputs the differential program with the software watermarking;
a software watermarking extracting section that extracts the software watermarking from the differential program with the software watermarking;
a program update section that generates an updated program by updating the original program using the differential program with the software watermarking; and
a watermark inserting section that inserts the software watermarking extracted from the differential program into the updated program.

11. A program unauthorized distribution prevention system comprising:
a distribution source that transmits an original program with a software watermarking, a differential program to update the original program, and a new software watermarking; and
the program software watermarking processing apparatus according to claim 2.

12. A program unauthorized distribution prevention system comprising:
a distribution source that transmits an original program with a software watermarking, and a differential program to update the original program; and
the program software watermarking processing apparatus according to claim 3.

13. A program unauthorized distribution prevention system comprising:
a program software watermarking inserting apparatus having:
an original program input section that inputs an original program;
a watermark inserting section that adds a software watermarking to the original program to generate the original program with the software watermarking;
an original program output section that transmits the original program with the watermark;
a differential program input section that inputs an update differential program to update the original program;
a program update section that generates an updated program by updating the original program using the update differential program;
a watermark inserting section that inserts a software watermarking into the updated program to generate the updated program with the software watermarking;
a differential program generating section that generates a user differential program to generate the updated program with the watermark from the original program with the watermark; and
a differential program transmitting section that transmits the user differential program, and
a program software watermarking processing apparatus having:
an original program input section that inputs the original program with the watermark;
a differential program input section that inputs the user differential program; and
a program update section that generates an updated program with the software watermarking from the original program with the watermark using the user differential program.

14. A program software watermarking processing method, comprising:
inputting an original program with a software watermarking;
inputting a differential program with a software watermarking to update the original program;
extracting the software watermarking from the differential program with the software watermarking;
generating an updated program by updating the original program using the differential program with the watermark; and
inserting the software watermarking extracted from the differential program into the updated program.

15. A program software watermarking processing method, comprising:
inputting an original program with a software watermarking;
inputting a differential program to update the original program;
inputting a new software watermarking;
generating an updated program by updating the original program using the differential program; and
inserting the new software watermarking into the updated program.

16. A program software watermarking processing method, comprising:
inputting an original program with a software watermarking;
inputting a differential program to update the original program;
extracting the software watermarking from the original program;
generating an updated program by updating the original program using the differential program; and
inserting the software watermarking extracted from the original program into the updated program.

17. A program software watermarking processing method, comprising:
inputting an original program with a software watermarking;
inputting a user differential program to generate an updated program with a software watermarking from the original program with the software watermarking; and
generating the updated program with the software watermarking from the original program with the software watermarking using the user differential program.

18. A program software watermarking processing method, comprising:
inputting an original program;
adding a software watermarking to the original program to generate the original program with the software watermarking;
transmitting the original program with the watermark;
inputting a differential program to update the original program;
inserting a software watermarking into the differential program to generate the differential program with the software watermarking; and
transmitting the differential program with the watermark.

19. A program software watermarking processing method, comprising:
inputting an original program;
adding a software watermarking to the original program to generate the original program with the software watermarking;
transmitting the original program with the watermark;
inputting an update differential program to update the original program;
generating an updated program by updating the original program using the update differential program;
inserting a software watermarking into the updated program to generate the updated program with the software watermarking;
generating a user differential program to generate the updated program with the watermark from the original program with the watermark; and
transmitting the user differential program.

20. A program having a computer execute processing of:
inputting an original program with a software watermarking;
inputting a differential program with a software watermarking to update the original program;
extracting the software watermarking from the differential program with the software watermarking;
generating an updated program by updating the original program using the differential program with the watermark; and
inserting the software watermarking extracted from the differential program into the updated program.

21. A program having a computer execute processing of:
inputting an original program with a software watermarking;
inputting a differential program to update the original program;
inputting a new software watermarking;
generating an updated program by updating the original program using the differential program; and
inserting the new software watermarking into the updated program.

22. A program having a computer execute processing of:
inputting an original program with a software watermarking;
inputting a differential program to update the original program;
extracting the software watermarking from the original program;
generating an updated program by updating the original program using the differential program; and
inserting the software watermarking extracted from the original program into the updated program.

23. A program having a computer execute processing of:
inputting an original program with a software watermarking;
inputting a user differential program to generate an updated program with a software watermarking from the original program with the software watermarking; and
generating the updated program with the software watermarking from the original program with the software watermarking using the user differential program.

24. A program having a computer execute processing of:
inputting an original program;
adding a software watermarking to the original program to generate the original program with the software watermarking;
transmitting the original program with the watermark;
inputting a differential program to update the original program;
inserting a software watermarking into the differential program to generate the differential program with the software watermarking; and
transmitting the differential program with the watermark.

25. A program having a computer execute processing of:
inputting an original program;
adding a software watermarking to the original program to generate the original program with the software watermarking;
transmitting the original program with the watermark;
inputting an update differential program to update the original program;
generating an updated program by updating the original program using the update differential program;
inserting a software watermarking into the updated program to generate the updated program with the software watermarking;
generating a user differential program to generate the updated program with the watermark from the original program with the watermark; and
transmitting the user differential program.

26. A storage medium that stores the program according to claim 20.
